(19) United States
(12) Patent Application Publication
(10) Pub. No.: US 2008/0046435 A1
(43) Pub. Date: Feb. 21, 2008

(54) Service discovery and automatic configuration

(75) Inventors: Eric B. Watson, Redmond, WA (US); Lingan Satkunanathan, Kirkland, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/506,234

(22) Filed: Aug. 18, 2006

(51) Int. Cl. G06F 17/30

(52) U.S. Cl. 707/10

(57) ABSTRACT

Described is a technology by which a client discovers services (e.g., Internet services) via a service listing server, and upon selecting a service, the client and/or service are automatically configured to couple to one another such that the client may host the service. In one example, a client includes or is associated with a mechanism that couples to the server listing server that maintains information regarding services, and communicates with that server to request available services. The service listing server returns a list, from which the client selects a service and returns configuration information needed by the service to be hosted. The service listing server evaluates and may modify the client configuration information as necessary to make the client compatible with the selected service. The client applies the modified configuration information to at least one client application or resource to configure the client for hosting the service.

### BACKGROUND

Computing in general is becoming more service oriented. For example, services delivered through the Internet to enterprises such as business customers include hosted email services, remote monitoring, backup services and so forth.

At the same time, the concept of an on-premise computing workload refers to devices, local programs and services that perform specific functions. For example, a workload may correspond to a network device such as a hardware firewall device, a network area storage (NAS) appliance, an edge device. Alternatively, a workload may be an application program or service such as email, a print service, a file service, a directory service, DHCP (Dynamic Host Configuration Protocol), monitoring services, web file sharing services and so forth.

At present, it is difficult to configure Internet-delivered (off-premise) services to work in an integrated fashion with such on-premise workloads. It is also difficult to discover which off-premise services are compatible with an existing environment. As a result, customer's environments are often disjointed from their service products, and service products are often underused relative to their potential usage and capabilities.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a client discovers services via a service listing server, and upon selecting a service, the client and/or service are automatically configured to couple to one another such that the client may host the service. The client includes or is associated with a mechanism that couples to a server listing server that maintains information regarding services to request available services. The service listing server returns a list, and the client selects a service. The service listing server evaluates whether the client is compatible with the selected service based on client-provided configuration information; the service listing server may modify the client configuration information as necessary to make the client compatible with the selected service. The client applies the modified configuration information to at least one client application or resource (e.g., a workload) to configure the client for hosting the service.

The service listing server thus receives a request for services from a client, and returns a list of services in response to the request. The service listing server receives a selected service from among the services in the list, and receives configuration information for the selected service, e.g., based on needed configuration information associated with each service in the list. The service listing server evaluates the configuration information to determine whether the client is compatible with the service, which may include reconfiguring the configuration information with data as necessary to make the client compatible with the selected service. The service listing server returns the configuration information, including any reconfigured data to the client, such that the client is capable of hosting the selected service. The service listing server may provision and configure an instance of the selected service for coupling to the client as a hosted service. The service listing server may receive other data from the client, such as data corresponding to payment for use of the service.

The client thus requests a list of services for a client via a communication with a service listing server and receives a list of services in response to the request, and also receives needed configuration information for at least one service. For a selected service, the client collects existing/current configuration information corresponding to the needed configuration information, and sends the collected configuration information to the service listing server. The client may receive modified configuration information, and if so, applies the modified configuration information to at least one application or resource (e.g., a workload) to configure the client for hosting the service.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative example of a general-purpose network computing environment into which various aspects of the present invention may be incorporated.

FIG. 2 is a block diagram representing components of a service listing server that provides lists of services and service-related information to a requesting client.

FIG. 3 is a block diagram representing components of an example client (e.g., a software suite) that requests services, selects a service, and configures itself for integrating the service based on communications with the service listing server.

FIG. 4 is a flow diagram showing an example user scenario and process flow for coupling a service to a client via a service listing server.

FIGS. 5 and 6 comprise representations of alternative ways by which programs may interact with a service discovery and configuration mechanism to obtain, select and configure the program to host a service via a service listing server.

FIG. 7 shows an illustrative example of a general-purpose computing environment including a computer into which various aspects of the present invention may be incorporated.

### DETAILED DESCRIPTION

Various aspects of the technology described herein are generally directed towards discovering remote (e.g., Internet) services, wherein in general, a service executes off-premise while interacting with one or more on-premise workloads in some way (unlike downloading a component for a program, for example). Examples of contemporary services include a hosted email service such as for email forwarding and spam filtering, a service for remote monitoring of an on-premise workload, a backup service and so forth, with the number and types of available services increasing rapidly.

Once discovered, a service can be selected and integrated for use with one or more workloads such as an on-premise software application program by configuring the workload to work with the service, and configuring the service to work with the workload, as necessary. Once configured and operational, the selected service is referred to herein as a hosted service. Note that the hosted service may be selected by administrator user input, for example, but may be selected in some other way, such as by an automated process, by an event, by time and so forth. Also, the service need not necessarily be an Internet service, but may, for example, be part of an enterprise network's intranet.

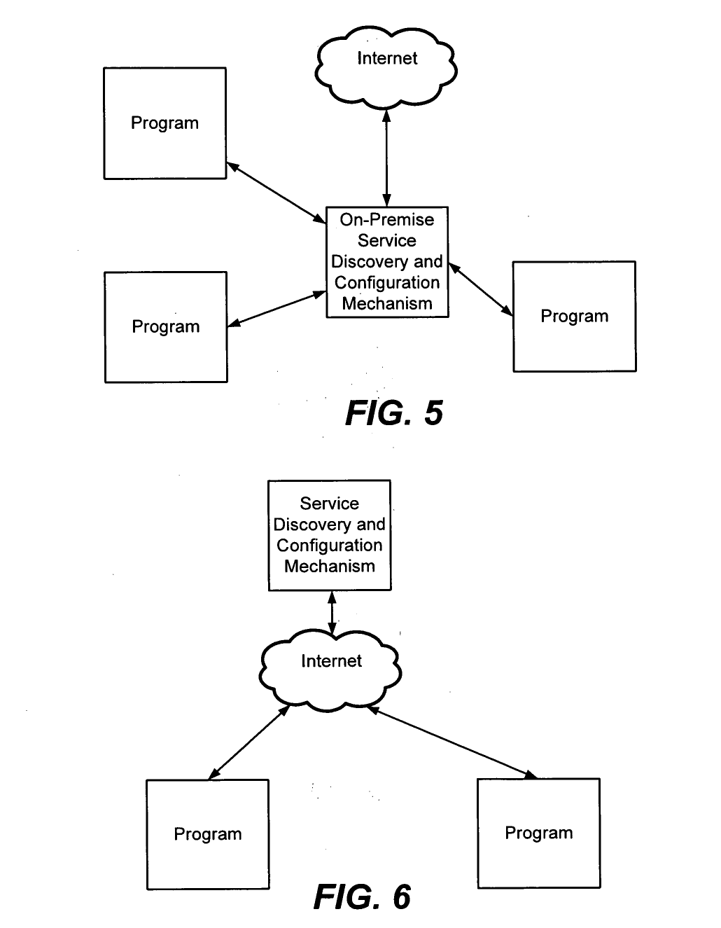

In one example implementation, at least some workloads are exemplified herein as being part of an on-premise suite of network-related software programs typically used in an information technology (IT) infrastructure. Examples of programs that may be present within such a suite include an administration console, an email server program, an antivirus and/or spam filtering program, a file server program, and so forth. Other on-premise workloads may be external to the suite. Notwithstanding, it can be readily appreciated that instead of a suite, a standalone program or other entity (e.g., a dedicated device) may include the discovery and configuration mechanism (e.g., FIG. 5), or the mechanism may be part of another program such as an application program or operating system component, and so forth. Indeed, some or all of the components of the discovery and configuration mechanism may not necessarily be literally on-premise and/or in one location, but rather can in whole or in part be accessed remotely, such as via a remote discovery and configuration service (FIG. 6) that is used by an on-premise computer program, for example.

As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and networking in general.

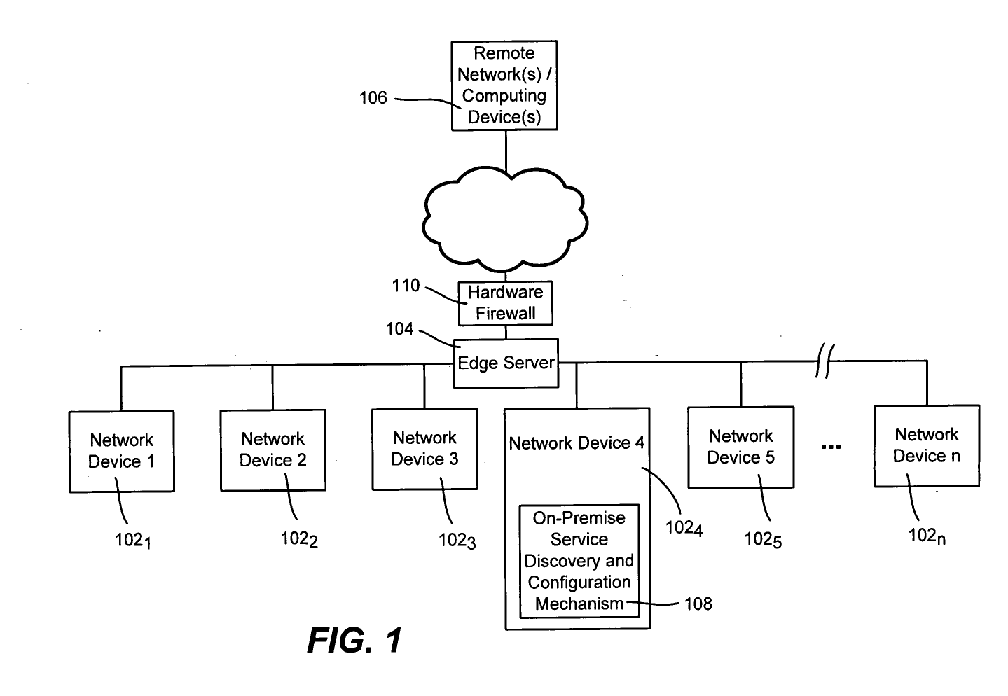

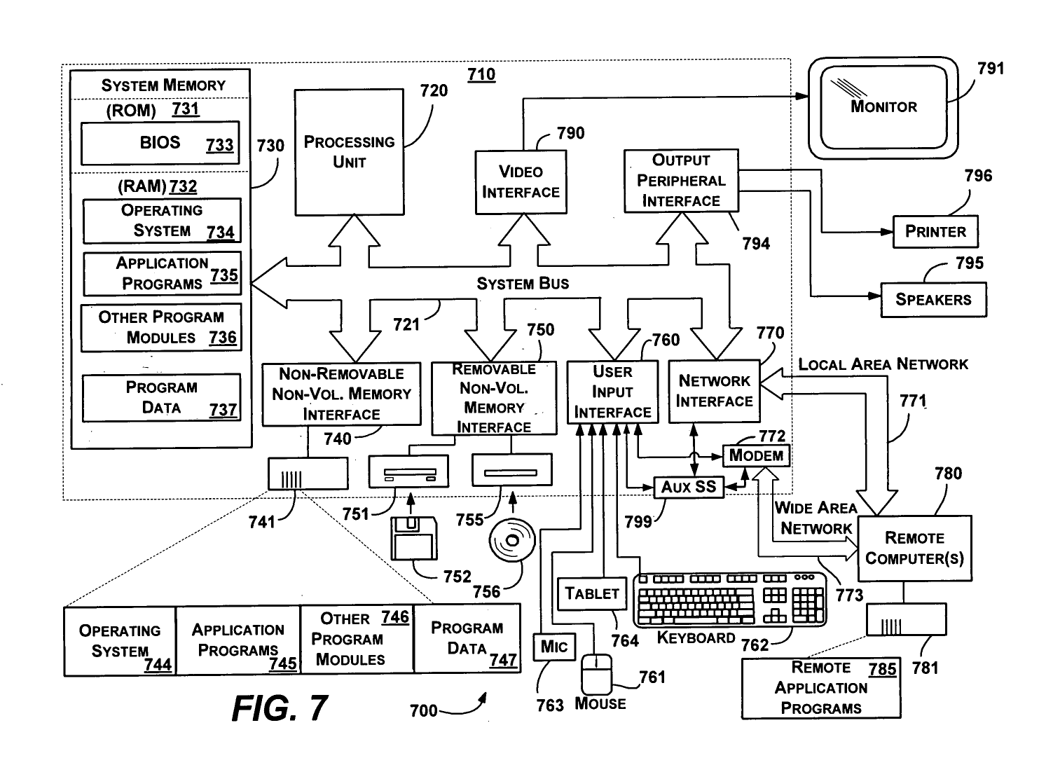

FIG. 1 shows an example network arrangement for a hypothetical enterprise, in which a number of computing devices 102₁-102ₙ are coupled via an edge server 104 to other remote networks and/or computing devices 106. The computing devices 102₁-102ₙ may be any device capable of running code and/or containing logic. Note that while an edge server 104 is shown within this example of FIG. 1, the technology described herein may apply to many other products and configurations, including one in which an edge server may not be present; indeed, as set forth above, the technology described herein concept may apply to a standalone machine (e.g., the computer 710 of FIG. 7), or a peer-to-peer network. Further, although not shown in FIG. 1, it is understood that various other networking components may be present, e.g., routers, switches, hubs, modems, and other hardware-based firewalls.

One of the computing devices (e.g., 102₄) is shown as maintaining an on-premise service discovery and configuration mechanism 108, which as described above need not be entirely “on-premise” in a literal sense. Further, it is understood that even in a configuration in which the service discovery and configuration mechanism 108 is literally “on-premise” within a network, the service discovery and configuration mechanism 108 may be distributed among more than one network device. Thus, for example, the service discovery and configuration mechanism 108 may comprise a program that runs at least in part on the edge server 104; further although not shown as such in the example of FIG. 1, the service discovery and configuration mechanism 108 may be a program that runs entirely on the edge server 104.

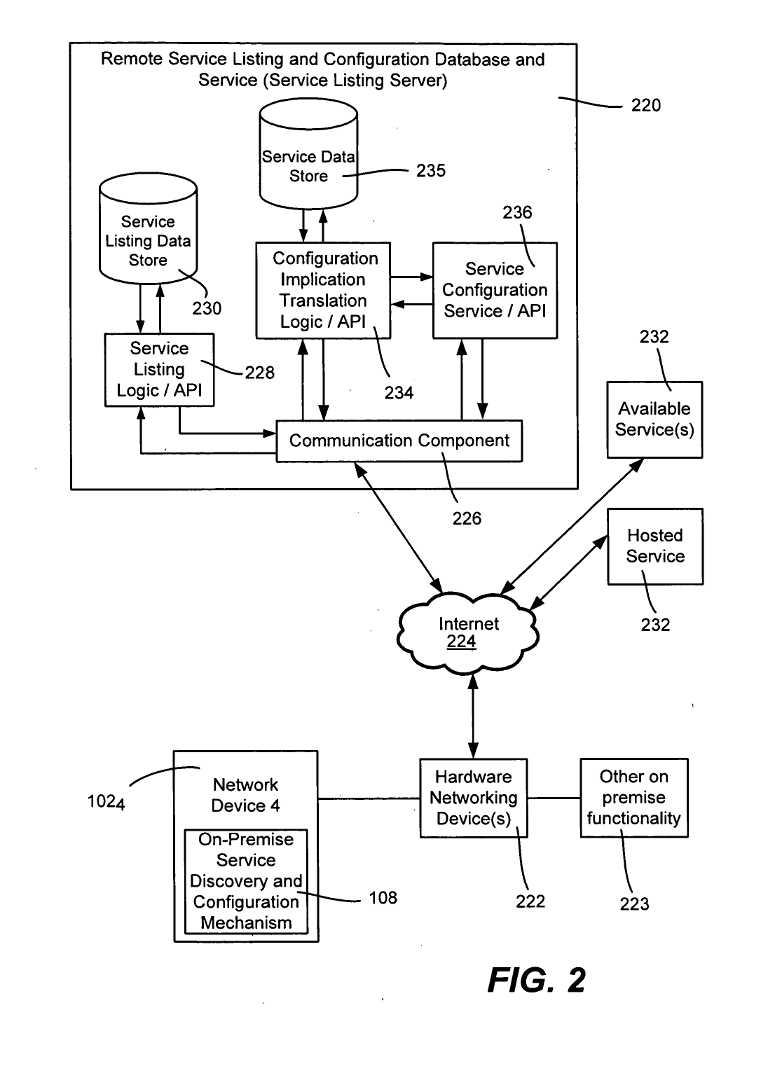

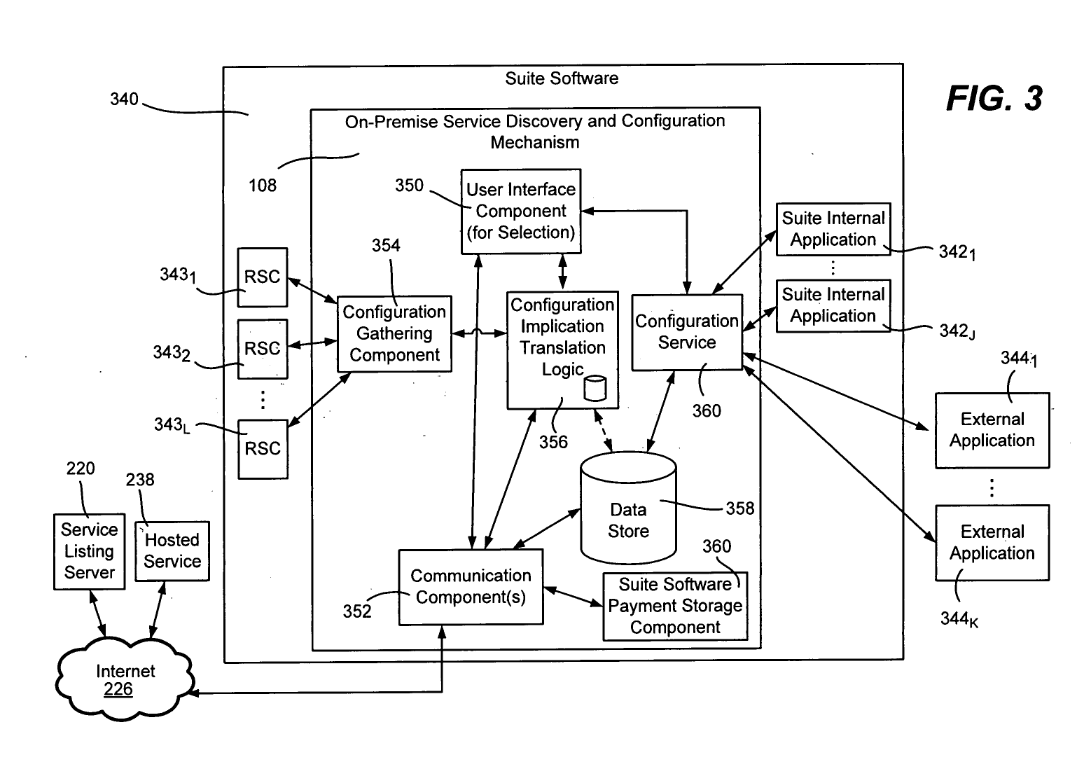

In one example implementation, via various example components within a remote service listing and configuration database and service 220 (FIG. 2) and various example components within the service discovery and configuration mechanism 108 (FIG. 3), there is provided the ability to discover services that an on-premise product such as a software suite 340 (FIG. 3) may be capable of hosting. The mechanism 108 further allows selection of one or more of those services, and thereafter operates to automatically configure the hosted service and one or more on-premise products to work together in an integrated way. The automatic configuring may also include the automatic provisioning of any resources (e.g., disk space, dedicated network bandwidth, dedicated CPU cycles, and so forth) necessary to integrate and run the hosted service and workload product, and possibly other workloads or services. As can be readily appreciated, this greatly simplifies the discovery and configuration for an integrated product solution (e.g., as if a full suite solution was locally hosted at one site). This may include built-in service security, configuration logic, service discovery logic, and/or the ability of an on-premise workload product to automatically configure multiple workloads.

In general, and as represented in FIG. 2, the service discovery and configuration mechanism 108 couples via one or more suitable hardware networking devices 222 (e.g., including the edge server 104 and the hardware firewall of FIG. 1) through the internet 224 to a communications component 226 or the like of the remote service listing and configuration database and service 220. For simplicity herein, the remote service listing and configuration database and service 220 will be alternatively referred to as the service listing server 220, to which the mechanism 108 acts as a client, although it is understood that the components shown therein need not operate in a single server device, but alternatively may be distributed and/or replicated across multiple servers, storage devices, and so forth. Note that also shown in FIG. 2 for completeness is other on-premise functionality 223, such as other workloads. The service listing server may be an isolated service or built-in to an aggregation of one or more services. The communication between the client and the service listing service may be via any existing or future standard protocol (e.g. SOAP, XML, HTTP(s), LDAP, DNS and so forth).

As represented in FIG. 2, the service listing server 220 includes the aforementioned communication component 226, and a service listing logic/API 228 which allows the service listing server 220 to send relevant listing data and other information to the service discovery and configuration mechanism 108. Such information may be maintained in a service listing data store database 230, and may comprise a set (referred to herein as a list, regardless of its actual format) of available services and their configuration information. Also, the service listing data store 230 may include any translation data that is needed to translate the settings that the service discovery and configuration mechanism 108 sends up (to determine what is needed for configuration for a workload) and settings the service needs. It should be noted that in general, the provider of the service listing server 220 separately works with the provider of each available service 230 to obtain the necessary configuration information, any needed translation logic, and the like. Indeed, it is likely that in many implementations, the service listing server 220 will only list services that are known to be trusted, acceptably dependable, and have possibly been pre-tested to ensure that the service will work as desired with client workloads.

The client may be configured to discover the service listing server in any number of ways, including manual and/or automatic means. For example, configuration may be through user input via a user interface, by a referral from another service listing server, and/or by a query to an external or internal directory service (e.g. DNS, UDDI, Active Directory, and so forth).

Note that the returned list of available services may be in the form of a full set of services relative to some workload or workloads, such as the entire set of services known to be trusted for a suite of products to which the service discovery and configuration mechanism 108 is associated. Alternatively, the list may comprise a filtered subset, such as only those available for a particular workload product.

Thus, a client may ask the service listing service to give all available services or provide the service listing service with a list of specific services. The initial response back to the client may be just the availability of specific services, all services, the necessary configuration information for services in the response, referral to one or more other service listing servers, or a combination of these. The configuration information returned may include only the information required to make the service functional, but also may include auxiliary information such as a pricing model for the service, service levels, license/certification information, or a combination of functional and auxiliary information.

By way of example, consider an administrator that runs a suite of products but wants to integrate a backup service into the suite. Through components of the mechanism 108 (described below with reference to FIG. 3), the administrator requests discovery of the services listed for that suite, and receives a list in return. Note that such a request may just request services for the suite, but alternatively may include filtering criteria, e.g., include only the full set of backup services (but no other services) available for that suite, include the full set of all services for a particular program of that suite, or include only backup services that apply to a particular program. Note that a list of services may be requested by the mechanism 108 (e.g., within the suite) for one or more programs that are external to the suite.

From the list, the administrator (or other process such as a ranking mechanism) makes a selection. While feasible to select more than one service at a time, for purposes of the description herein, selection of a single service at a time is described. Note that while the list may be returned as just a simple list of services (possibly with related information describing each service), the list may be returned along with information that specifies what configuration information (which may differ from service to service) is needed for each service to operate. In the first alternative in which only the list is provided, additional communication may be used to have the client request the needed configuration information for a selected service, and then return that configuration information to the service listing server 220. For purposes of this example description, in general, the client requests a list of services, receives the list, selects a service and returns information that identifies the selected service and provides the needed configuration information to the service listing server 220, regardless of how many actual communications take place.

Based on the selection, which is sent back to the server listing server's communication component 226, configuration implication translation logic 234 of the server listing server 220 takes any settings provided by the service discovery and configuration mechanism 108. From these settings, the configuration implication translation logic 234, using data in a service data store 235 determines whether the selected service is not compatible with the client based on its configuration settings, or if compatible, whether any settings within the selected service that need to be changed or added. For example, if the client identifies itself as a suite of application programs, the configuration implication translation logic 234 may translate or add settings for individual programs A, B, C and D of that suite. Thus, there may be settings translated for the explicit settings provided by the mechanism 108 (that is, the client) that allow the selected service to couple to the client without impacting the client, for example, and there may be implied settings that the translation logic 234 may add to facilitate coupling the'service to the client.

A service configuration service/API 236 takes the direct client configuration information and any translated/derived client configuration information, and returns any needed changes to the service discovery and configuration mechanism 108. From this, the client may reconfigure any of its workloads and/or resources to match these settings. For example, a client may have to change its mail exchange (MX) record to work with an email-related service, or its IP address, and so forth. Note that a client can be set up to reject-a particular change, in which event the administrator may select another service and try again.

Following the client's configuration of its workloads and resources, the selected service and service discovery and configuration mechanism 108 are configured to communicate with each other, (at least to the extent necessary to further exchange needed information, such as proprietary information not desirable to exchange via the service listing server 220). At this time, assuming the communication to the service succeeds and other possible connection requirements are met (such as providing credentials, providing a certificate and/or other requirements), the service discovery and configuration mechanism 108 can be considered as hosting the hosted service 238. For example, the service listing server 220 may provision and configure an instance of the selected service with the necessary resources configured for the client's settings, and facilitate coupling of the client to this instance. Note that hosting may include coupling to multiple services in parallel, coupling to multiple services in series, or a combination of parallel and series coupling.

FIG. 3 describes an example implementation in which the service discovery and configuration mechanism 108 is part of suite software 340, and contains the components that allow discovery hosted service and automatic configuration of the client resources and workloads. Note that this may include other suite-internal applications 342₁-342ⱼ and applications 344₁-344_{K} that are external to the suite 340.

In the example implementation of FIG. 3, the exemplified components of the suite software 340 include the above-described on-premise service discovery and configuration mechanism 108. A user interface component 350 allows a request for services to be made by an administrator, and for a service to be selected for hosting, assuming it can be hosted. Note that the user interface component 350 may be external to the mechanism 108, such as in an administrator console that interacts with the mechanism 108.

A communication component 352 communicates the request for services to the service listing server 220. When the list is returned and a service is selected, the needed configuration data is known to the mechanism 108. Based on this needed configuration data, a configuration gathering component 354 may collect information from the suite-internal applications 342₁-342_{J} and external applications 344₁-344_{K}, as well as from various resources 343₁-343_{L}. Configuration information also may be collected from one or more devices in the local network; the local network may be distributed across multiple locations. Note that in general, the configuration gathering component 354 ordinarily collects configuration information from only those resources which are relevant to a service. Further note that in FIG. 3, arrows are not shown between the configuration gathering component 354 and the suite-internal applications 342₁-342_{J} and external applications 344₁-344_{K} for purposes of clarity in the drawing.

As described above, the gathered settings are sent to the service listing server 220, where they are evaluated and translated as necessary, and returned. Configuration implication translation logic 356 takes the possibly-modified settings from the service listing server 220 and via its own logic and a data store 358, derives any settings within the suite 340, suite-internal applications 342₁-342_{J}, external applications 344₁-344_{K} and resources 343₁-343_{L} that need to be changed.

A configuration service 360 applies any needed changes to the suite, the suite-internal applications 342₁-342_{J}, external applications 344₁-344_{K} and resources 343₁-343_{L}. Note that in FIG. 3, arrows are not shown between the configuration gathering component 354 and the resources 343₁-343_{L} for purposes of clarity in the drawing. Further, note that the application or resource can be on the same machine or distributed among multiple devices in the local network; the local network could be distributed across multiple locations.

At this time, the suite is configured for hosting the service, and communication between the suite and the hosted service 238 may occur. Additional services may be discovered and hosted in a similar manner. Note that the configuration settings may be backed up at the client, so that if the service becomes unavailable and the client needs to reconfigure itself for another service, for example, the client may later restore the settings when the original service again becomes available and rapidly host the original service again.

As also represented in FIG. 3, one or more other components may be present, such as a software payment storage component 360 configured for transmitting payment data via the communication component 352. The transmission may be to the hosted service 238, to the service listing server 220, or to some other site as appropriate. Note that any other information may be exchanged, e.g., licensing data, credentials, a certificate, an encryption key and so forth as appropriate for the service.

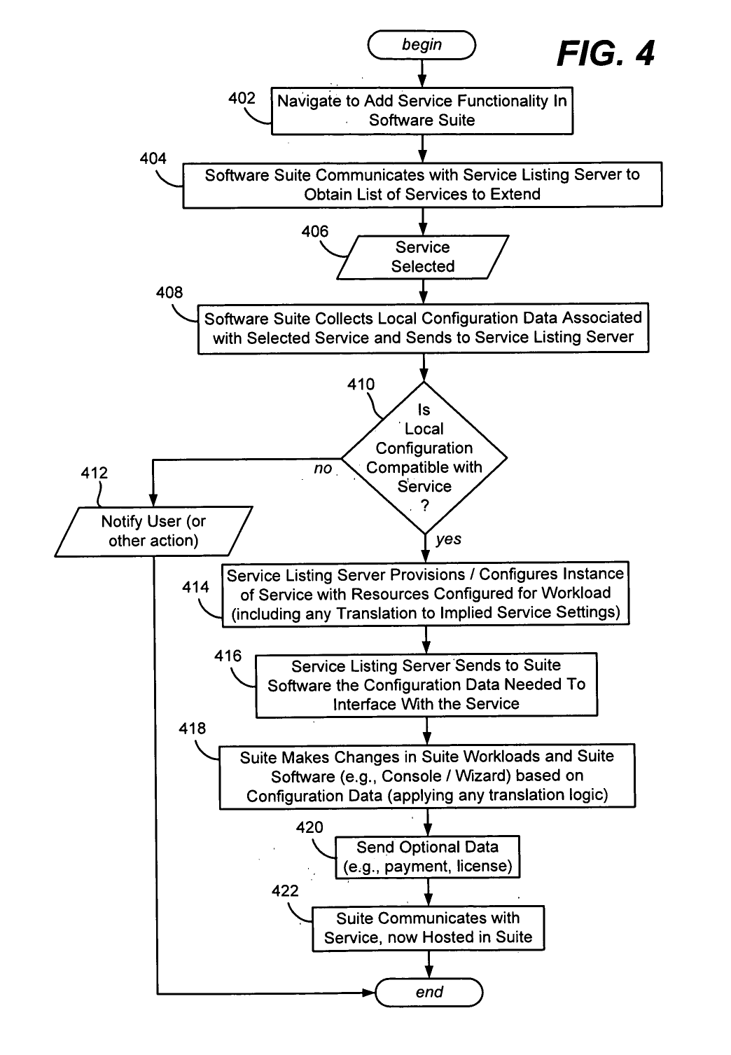

FIG. 4 is a representation of an example user scenario and process flow. Note that the steps of FIG. 4 are only examples, and may be performed in an order different from that shown. Further, the example of FIG. 4 is generally directed towards a user (e.g., administrator) scenario, but it can be readily appreciated that another process such as an automated process may perform the user actions. Moreover, FIG. 4 is described in the context of a suite of network-related programs (e.g., the suite software 340) implicitly including network administration software such as an interactive console, wizard or the like; in FIG. 4 the suite software is described as communicating with the service listing server 220 (rather than the mechanism 108) and eventually hosting the selected service.

The example process described in FIG. 4 begins at step 402, which represents a user navigating to an add service functionality section of the suite software or the like, such as via an administration console subsection or wizard. Note that this navigation implies that the suite software is already running; if not, the suite software is first started up.

At step 404, a list of services is obtained by communicating between the suite software (e.g., via an internal mechanism such as the mechanism 108 or via an external mechanism as in FIGS. 5 and 6) and the service listing server 220, as described above. Assuming successful communication, which may include verifying credentials and the like, a list of services to extend the suite is returned, and the user is shown the list. Note that as described above, some pre-filtering may be performed to filter the list, such as by having the suite scan its programs and/or identify one or more beforehand, but for purposes of this example, the list contains the available services corresponding to the suite. Step 406 represents a user having selected a service to add.

Once a selection is made and the needed configuration data known, the suite software collects the various configuration data associated with the service, and sends it to the service listing server 220. The transmission may be secure, e.g., via SSL and/or to an address of a trusted service listing server built into the software suite.

Step 410 service then represents the service listing server 220 performing a compatibility check of the client data (of the suite in this example), essentially detecting if the suite's collected configuration is compatible with the selected service's offerings. If the local configuration is not compatible, then the user is notified of this (or some other action taken) as represented at step 412.

If the local configuration is deemed compatible at step 410, then at step 414 the service listing server 220 provisions and configures an instance of the selected service with the necessary resources configured for the suite-specific and installation-specific settings passed up to the service listing server 220. Note that as described above, additional logic may be required to translate the software suite configuration to implied service settings.

At step 416, the service listing server 220 sends down to the suite software the configuration data needed to interface with the selected service. At step 418, the software suite takes the data, applying logic as necessary to translate the required settings into the various workloads (applications and/or resources) and also may make changes to the suite software itself, e.g. to the administration console and/or user wizard.

As represented by step 418, payment for the service or other information such as valid license data for the use of the service may be sent through the same channel, e.g., up to the service listing site and forwarded to the provider.

At this time, the software suite is configured for use with the now-hosted service, and vice-versa as necessary, whereby the user sees the service active in the software suite. For example, the user will see the service integrated into the appropriate places in the workloads and centralized software. Further, any other resources (e.g., disk space, dedicated network bandwidth, dedicated CPU cycles, and so forth) are automatically provisioned as appropriate for use with the service.

### Exemplary Operating Environment

FIG. 7 illustrates an example of a suitable computing system environment 700 on which the dynamic program support links mechanism 108 (FIG. 2) may be implemented. The computing system environment 700 is only one example of a suitable computing environment and is not intended to suggest any limitation as to the scope of use or functionality of the invention. Neither should the computing environment 700 be interpreted as having any dependency or requirement relating to any one or combination of components illustrated in the exemplary operating environment 700.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 7, an exemplary system for implementing various aspects of the invention may include a general purpose computing device in the form of a computer 710. Components of the computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 710 typically includes a variety of computer-readable media. Computer-readable media can be any available media that can be accessed by the computer 710 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 710. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736 and program data 737.

The computer 710 may also include other removable/non-removable, volatile/nonvolatile computer storage media. By way of example only, FIG. 7 illustrates a hard disk drive 741 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface, such as interface 750.

The drives and their associated computer storage media, described above and illustrated in FIG. 7, provide storage of computer-readable instructions, data structures, program modules and other data for the computer 710. In FIG. 7, for example, hard disk drive 741 is illustrated as storing operating system 744, application programs 745, other program modules 746 and program data 747. Note that these components can either be the same as or different from operating system 734, application programs 735, other program modules 736, and program data 737. Operating system 744, application programs 745, other program modules 746, and program data 747 are given different numbers herein to illustrate that, at a minimum, they are different copies. A user may enter commands and information into the computer 710 through input devices such as a tablet, or electronic digitizer, 764, a microphone 763, a keyboard 762 and pointing device 761, commonly referred to as mouse, trackball or touch pad. Other input devices not shown in FIG. 7 may include a joystick, game pad, satellite dish, scanner, or the like. These and other input devices are often connected to the processing unit 720 through a user input interface 760 that is coupled to the system bus, but may be connected by other interface and bus structures, such as a parallel port, game port or a universal serial bus (USB). A monitor 791 or other type of display device is also connected to the system bus 721 via an interface, such as a video interface 790. The monitor 791 may also be integrated with a touch-screen panel or the like. Note that the monitor and/or touch screen panel can be physically coupled to a housing in which the computing device 710 is incorporated, such as in a tablet-type personal computer. In addition, computers such as the computing device 710 may also include other peripheral output devices such as speakers 795 and printer 796, which may be connected through an output peripheral interface 794 or the like.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although only a memory storage device 781 has been illustrated in FIG. 7. The logical connections depicted in FIG. 7 include one ore more local area networks (LAN) 771 and one or more wide area networks (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the user input interface 760 or other appropriate mechanism. A wireless networking component 774 such as comprising an interface and antenna may be coupled through a suitable device such as an access point or peer computer to a WAN or LAN. In a networked environment, program modules depicted relative to the computer 710, or portions thereof, may be stored in the remote memory storage device. By way of example, and not limitation, FIG. 7 illustrates remote application programs 785 as residing on memory device 781. It may be appreciated that the network connections shown are exemplary and other means of establishing a communications link between the computers may be used.

An auxiliary subsystem 799 (e.g., for auxiliary display of content) may be connected via the user interface 760 to allow data such as program content, system status and event notifications to be provided to the user, even if the main portions of the computer system are in a low power state. The auxiliary subsystem 799 may be connected to the modem 772 and/or network interface 770 to allow communication between these systems while the main processing unit 720 is in a low power state.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computer network, a method comprising:
publishing one or more points of service directories for clients to query;
receiving a request for services from a client;
returning a list of services in response to the request;
receiving information corresponding to a selected service from among the services in the list and configuration information for the selected service;
evaluating the configuration information to determine whether the client is compatible with the service, including reconfiguring the configuration information with data as necessary to make the client compatible with the selected service; and
returning the configuration information including any reconfigured data to the client such that the client is capable of hosting the selected service.

2. The method of claim 1 further comprising, for each service in the list of services, returning a set of needed configuration information corresponding to that service.

3. The method of claim 1 further comprising, requesting the services for the client via a communication with a service listing server, receiving the list of services in response to the request, and receiving needed configuration information for at least one service including the selected service.

4. The method of claim 3 further comprising, collecting the configuration information corresponding to the needed configuration information and sending the collected configuration information to the service listing server.

5. The method of claim 3 further comprising, receiving the modified configuration information from the service listing server, and applying the modified configuration information to at least one application or resource to configure the client for hosting the service.

6. The method of claim 1 further comprising, provisioning and configuring an instance of the selected service for coupling to the client as a hosted service.

7. The method of claim 1 further comprising, receiving at least one additional set of information related to hosting the service from the client, the additional set corresponding to: payment information, a certificate, credentials, or license-related information, or any combination thereof.

8. In a computer network, a method comprising:
requesting services for a client via a communication with a service listing server;
receiving a list of services in response to the request;
receiving needed configuration information for at least one service;
collecting configuration information corresponding to the needed configuration information at the client for a selected service;
sending the collected configuration information to the service listing server;
receiving modified configuration information from the service listing server; and
applying the modified configuration information to at least one application or resource to configure the client for hosting the service.

9. The method of claim 8 further comprising, coupling to the service based on at least part of the modified configuration information such that the service is hosted in the client.

10. The method of claim 8 further comprising, sending at least one additional set of information related to hosting the service, the additional set corresponding to: payment information, a certificate, credentials, or license-related information, or any combination thereof.

11. The method of claim 8 further comprising, at the service listing server, receiving the request for the services, and returning the list of services in response to the request, or providing a referral to another service listing service for certain service requests, or both returning the list of services and providing a referral.

12. The method of claim 11 further comprising, receiving information corresponding to the selected service from among the services in the list and configuration information for the selected service, evaluating the configuration information to determine whether the client is compatible with the service, including reconfiguring the configuration information into the modified configuration information, and returning the modified configuration information to the client.

13. In a computer network, a system comprising:
a service listing server that maintains information regarding services;
a mechanism that couples to the server listing server to request available services for a client, and to return a selected service to the service listing server;
means associated with the service listing server for evaluating whether the client is compatible with the selected service based on client configuration information, including modifying the client configuration information into modified client configuration information to make the client compatible with the selected service; and
means associated with the client for applying the modified configuration information to at least one client application or resource to configure the client for hosting the service.

14. The system of claim 13 wherein the mechanism is incorporated into a program of the client.

15. The system of claim 13 wherein the mechanism is incorporated into a service external to the client.

16. The system of claim 13 wherein the client comprises a suite of network-related programs, and wherein the mechanism is incorporated into the suite

17. The system of claim 13 wherein the mechanism couples to the server listing server via the Internet.

18. The system of claim 13 further comprising means for configuring the client-:to discover the service listing server, including manual configuration by via a user interface, a referral from another service listing server, or a query to an external or internal directory service, or any combination thereof.

19. The system of claim 13 wherein the service listing server is an isolated service.

20. The system of claim 13 wherein the service listing server is part of an aggregation of one or more services.
